(19) United States
(12) Patent Application Publication
(10) Pub. No.: US 2016/0069776 A1
(43) Pub. Date: Mar. 10, 2016

(54) Pattern Search in Analysis of Underperformance of Gas Turbine

(71) Applicant: Siemens Aktiengesellschaft, Munich (DE)

(72) Inventors: Xinmin Cai, Chatham, NJ (US); Chao Yuan, Plainsboro, NJ (US); Amit Chakraborty, East Windsor, NJ (US)

(21) Appl. No.: 14/813,244

(22) Filed: Jul. 30, 2015

Related U.S. Application Data
(60) Provisional application No. 62/047,984, filed on Sep. 9, 2014.

(51) Int. Cl. G01M 15/14

(52) U.S. Cl. CPC G01M 15/14

(57) ABSTRACT

Reference data from sensors measuring characteristics of a gas turbine are analyzed to identify underperformance of the gas turbine, which may be a predictor of an unscheduled shutdown. Time series data from the sensors are compared to annotated query data using an open-begin-end dynamic time warping algorithm. Identified subsequences are examined as possible underperformance indicators. In a related technique, multiple time series from the sensors are pairwise compared using a dynamic time warping algorithm, and computed distances between the time series are used to group the time series using a hierarchical clustering algorithm. The clusters are examined to identify underperformance indicators.

### CROSS-REFERENCE TO RELATED APPLICATIONS

This application claims the benefit of co-pending U.S. Provisional Patent Application entitled “PATTERN SEARCH IN ANALYSIS OF UNDERPERFORMANCE OF GAS TURBINE” filed on Sep. 9, 2014 and assigned Ser. No. 62/047,984, the contents of which is hereby incorporated by reference in its entirety herein.

### BACKGROUND OF THE INVENTION

1. Field of the Invention

The invention relates generally to the monitoring of gas turbines. More specifically, the invention addresses the long-term monitoring of gas turbine sensor data to detect underperformance events that may be predictors of unplanned shutdowns.

2. Description of the Prior Art

The gas turbine has been widely used for producing electricity. As one of the major parts of a power plant, each gas turbine (a unit) is monitored by groups of sensors. The sensors monitor different aspects of a gas turbine, such as megawatt (MW) output and rotations per minute (RPM). Sensor readings are at the core of gas turbine performance analysis.

For power plants, any unexpected shutdown will lead to substantial economic costs. Underperformance of a gas turbine for days, weeks or even months may precede an unexpected shutdown. A need exists for techniques to detect such an underperformance from the sensor data, and to analyze the sensor data to identify suspicious periods that may indicate underperformance.

### SUMMARY OF THE INVENTION

Needs in the art are addressed in embodiments of the disclosure by a computer-implemented method for detecting an underperformance of a gas turbine based on a plurality of reference time series of sensor readings. The method includes standardizing the plurality of reference time series; determining pairwise distances between each pair of the plurality of reference time series using a dynamic time warping algorithm having a symmetric step pattern; clustering the candidate subsequences into classes using a hierarchical clustering algorithm based on the pairwise distances; and detecting the underperformance of the gas turbine based on analysis of the classes.

In other embodiments, a computer-implemented method for detecting an underperformance of a gas turbine based on a reference time series of sensor readings is provided. That method includes accessing an annotated query time series of sensor readings, the annotated query time series containing at least one identified pattern indicating underperformance of a gas turbine; selecting a candidate subsequence of the reference time series best matching the annotated query time series based on a minimized distance between the two time series using an open-begin-end dynamic time warping algorithm releasing a boundary condition of the reference time series; removing from the reference time series the candidate subsequence best matching the annotated query time series together with time intervals before and after the candidate subsequence; repeating the selecting and removing until a predetermined number of candidate subsequences is identified; and detecting the underperformance of the gas turbine based on the candidate subsequences and the minimized distances.

Other embodiments comprise a computer-readable storage device having stored thereon computer readable instructions for detecting an underperformance of a gas turbine based on a plurality of reference time series of sensor readings, wherein execution of the computer readable instructions by a processor causes the processor to perform operations comprising those described above.

The respective features of the exemplary embodiments of the invention may be applied jointly or severally in any combination or sub-combination by those skilled in the art.

### BRIEF DESCRIPTION OF THE DRAWINGS

The exemplary embodiments can be readily understood by considering the following detailed description in conjunction with the accompanying drawings, in which:

FIG. 1 shows a graphical visualization of a distance matrix showing distances between indexed points in reference data and a query series, with a boundary condition.

FIG. 2 shows a graphical visualization of an alignment between indexed points in reference data and a query series, with a boundary condition.

FIG. 3 shows a graphical visualization of a distance matrix showing distances between indexed points in reference data and a query series, without a boundary condition.

FIG. 4 shows a graphical visualization of an alignment between indexed points in reference data and a query series, without a boundary condition.

FIG. 5 shows a graphical visualization of a simple step pattern used in an algorithm for searching a distance matrix for a warping path.

FIG. 6 is a flow chart showing methods for identifying turbine underperformance according to the present disclosure.

FIG. 7 shows graphical representations of standardized sensor data used in an example implementation of the presently disclosed technique.

FIG. 8 is a graphical representation of a step pattern used in an algorithm for searching a distance matrix for a warping path used in an example implementation of the presently disclosed technique.

FIG. 9 shows graphical representations of the top three matched sensor data patterns a single-sensor example implementation of the presently disclosed technique.

FIG. 10 shows graphical representations of the top three matched sensor data patterns a multiple-sensor example implementation of the presently disclosed technique, visualized by individual sensors.

FIG. 11 is chart showing results of multi-dimensional hierarchical clustering according to an example implementation of the presently disclosed technique.

To facilitate understanding, identical reference numerals have been used, where possible, to designate identical elements that are common to the figures.

### DETAILED DESCRIPTION

Underperformance of a gas turbine is usually a sign of an impending unplanned shutdown. The benefit of being able to identify underperformance in a gas turbine is therefore tremendous. In the present disclosure, Dynamic Time Warping (DTW) is proposed as a method for underperformance detection.

DTW is an algorithmic technique for measuring the similarity of two time series, even if the two time series are of different lengths. One of the advantages of DTW is that it is able to stretch or compress time series and find the “best” matched patterns. That advantage is useful in underperformance detection for gas turbines because the length of the underperformance periods may vary depending on different situations and different equipment units. Traditional techniques cannot handle that characteristic as well as DTW.

One of the challenges in using DTW to predict an unexpected shutdown, such as a forced outage, is that empirical data describing underperformance is typically not available. Specifically, it cannot be explicitly distinguished in the historical data whether a unit is operating normally or operating abnormally.

The formal description of the problem of interest is as follows. Let a matrix Y_{T×P} denote readings of P sensors of a single gas turbine unit over the time period T. Y_{T×P} is often called the reference data in DTW. Each element of Y_{T×P}, yᵢⱼ, represents a reading of the jth sensor at the ith time point. Let a matrix X′_{T′×P′} denote the query series, which has the same number of columns but a different length. If D denotes the distance, or dissimilarity, between two time series, the matched patterns will have the minimized D.

Based on the calculated DTW distance, several investigations may be carried out. First, if the query data contains a pattern of underperformance, then the matched part of reference data might indicate underperformance. Next, a cross distance matrix may be calculated in a similar way to measure the pairwise dissimilarity of sensor readings within different time periods. Unsupervised clustering methods or supervised classification methods may then be carried out to cluster events into small clusters for further analysis.

A summary of the analysis operations performed on real sensor data in accordance with embodiments of the invention may include the following: 1) The raw sensor data is pre-processed. 2) Global and local constraints, such as step pattern choice and global window size, are determined. 3) An annotated data is used as query data to identify similar patterns in reference data. 4) Unsupervised hierarchal clustering or a supervised classification technique is performed on annotated sensor readings.

The basic underlying principles and implementation of DTW and its constraints will now be reviewed. Dynamic Time Warping was originally developed by Hiroaki Sakoe and Seibi Chiba for speech recognition, as described in Hiroaki Sakoe and Seibi Chiba, “Dynamic Programming Algorithm Optimization for Spoken Word Recognition”, IEEE Transactions on acoustics, speech, and signal processing, vol. ASSP-26, NO. 1 February 1978 (“Sakoe et al.”), the contents of which is hereby incorporated by reference in its entirety herein. Dynamic Time Warping aligns two sequences (e.g. time series) in a non-linear way. Consider two one-dimensional time series X of length N and Y of length M. To compare the two series, a distance function is defined as

c:F×F→R≧0.

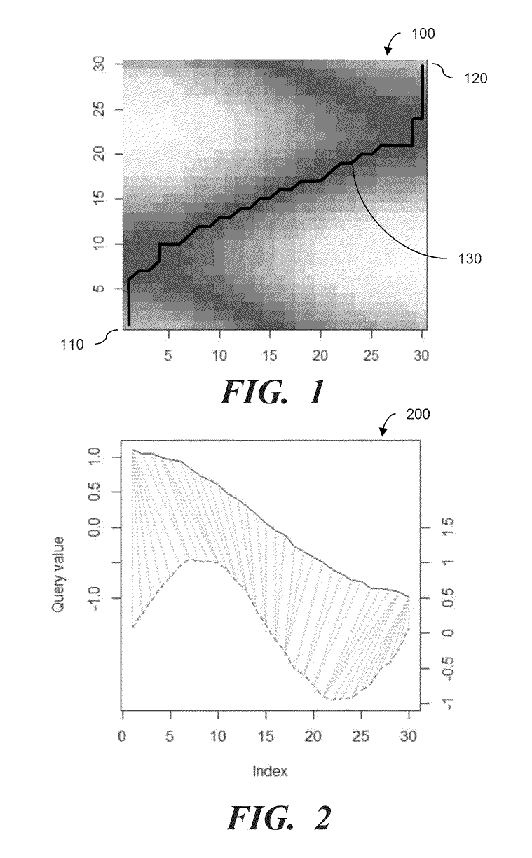

Usually, the distance function is a Euclidean distance function or a Manhattan distance function. Based on the defined distance function, one can calculate the distance matrix, C∈R^{N×M}. Each element of C, Cₙₘ, is the distance between Xₙ, the nth value of X, and Yₘ, the mth value of Y. A visualization 100 of a cross distance matrix C is shown in FIG. 1, wherein the bottom-left corner 110 is the starting point for both time series X and Y and the top-right corner 120 is the ending point for both time series. The lighter shading indicates a larger distance between indexed points represented by the two axes. A path 130 through the distance matrix C has a minimum accumulated distance between the two time series. A resulting alignment 200 of respective points of the two times series X and Y is shown in FIG. 2.

The basic mechanism employed by dynamic time warping is to find a path through the distance matrix, from the lower left corner to the top right corner, that has a minimum sum of distances. The resulting path crossing the distance matrix is called the warping path, denoted by p. The classical DTW warping path satisfies three conditions: a boundary condition, a monotonicity condition, and a step size condition, as described by Muller, M, “Information Retrieval for Music and Motion”, Chapter 4, 2007, Springer, ISBN: 978-3-540-74047-6 (“Muller”), the contents of which are incorporated by reference herein in their entirety. The boundary condition requires that the path should start from the most lower-left corner and end at the most top-right corner in the distance matrix defined as above. The monotonicity condition requires that the path cannot go left or down in the distance matrix defined as above. The step size condition means the path cannot skip any points on either time series. As described later in this disclosure, the step size condition may be released when stretching and compression is desired, as is done in the present analysis. To calculate the optimal warping path, an optimal warping path algorithm, such as that described by Muller, is employed. The implementation of DTW in the R statistical software is described in detail by Toni Giorgino, “Computing and Visualizing Dynamic Time Warping Alignments in R: The dtw Package”, Journal of Statistical Software, August 2009, Vol. 31, Issue 7, the contents of which are incorporated by reference herein in their entirety.

In the case of the presently described gas turbine application, the reference data and query data are frequently extremely disproportional in length. For example, in the present analysis, about four and half years of reference sensor data is provided, while the query data covers two to three months. Only a subsequence of whole sensor data sequence is expected to be matched with the query data. To achieve this, the boundary condition is released, implementing a so-called open-begin-end DTW (OBE-DTW). A modified version of the optimal warping path algorithm, as also described by Muller, is used for obtaining the optimal warping path for OBE-DTW. The idea of OBE DTW is to remove the penalty of skipping reference data at the beginning and the end of the warping path.

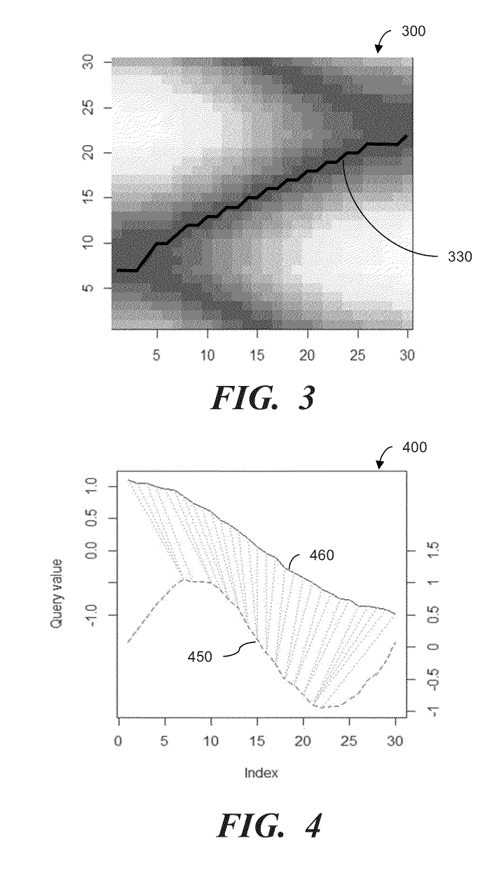

A visualization 300, shown in FIG. 3, illustrates results including a warping path 330 for the same data as in FIGS. 1 and 2, but processed using a DTW algorithm without boundary condition. The matched pattern alignment 400 between the reference data 450 and the query data 460, shown in FIG. 4, is more reasonable than results with boundary conditions illustrated in FIGS. 1 and 2. Specifically, the optimal warping path 330 starts from the 7th data point of the reference data 450 and ends at the 22nd data point.

In implementing DTW, there are several local and global constraints that must be carefully specified. A monotonicity constraint is always imposed on the implementation of DTW because of the nature of time series. The boundary condition, as noted above, may be released when a subsequence is desired. In the case of gas turbine monitoring, the boundary condition is released and leads to OBE-DTW.

Another condition used in DTW is a warping window. The warping window is a selected area of the cross distance matrix outside of which the warping path is not permitted to traverse. Setting the warping window not only speeds up the DTW calculation, because the path search area is reduced to within the window, but also assures that the path won't skip or become stuck at one time point. There are several well-known warping windows used in DTW, including the Sakoe-Chiba band and the Itakura parallelogram.

A step size condition is also used to constrain the algorithm. As noted above, the step size condition ensures that the path won't skip any data points. In certain applications, however, that is not a desired feature. The patterns in reference data may have different lengths, but carry the same information. In the presently discussed application of gas turbine monitoring, underperformance before an unexpected shutdown can last for weeks or months.

The sum of the distances of the optimal warping paths should be normalized to remove the impact of different lengths when making a comparison between different pairs of time series. Otherwise, the longer the time series, the larger the distance will be. For that purpose, the selected step patterns should be normalizable. Usually, the asymmetric step patterns are suitable for subsequence search and are normalizable. Greater detail may be found in Muller.

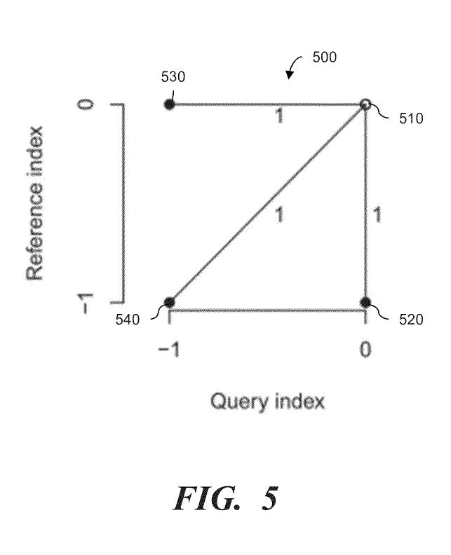

An important component of DTW is the step pattern, a constraint that confines the DTW algorithm to search for the best warping path in a specific way. For example, if the step pattern is similar to the pattern 500 shown in FIG. 5, the algorithm will only search the warping path to any individual point 510 from the solid dots 520, 530, 540. Thus, a constraint of the slope of the warping path is imposed.

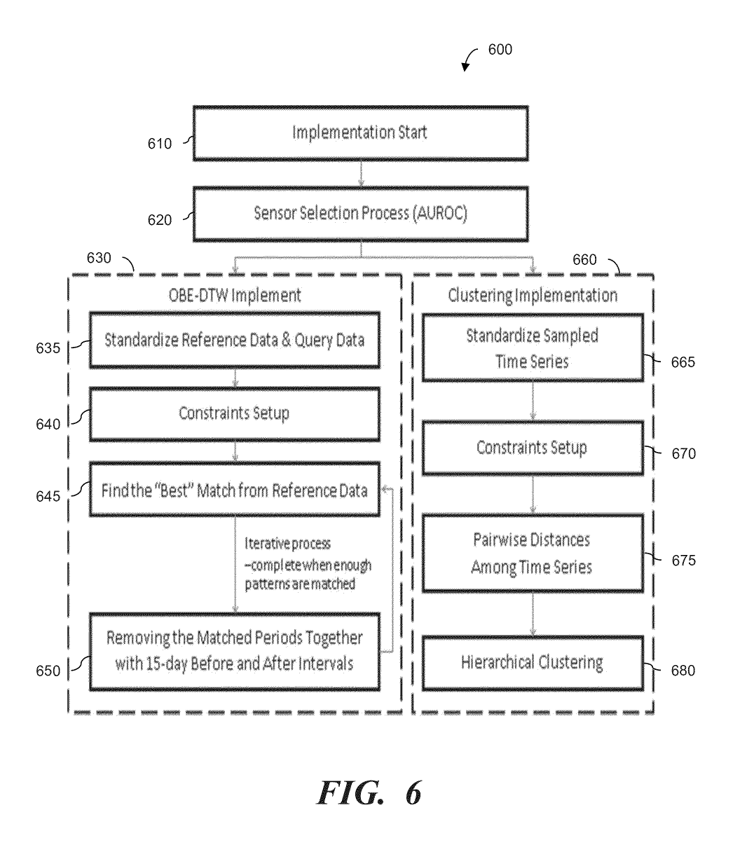

An implementation flow chart 600 depicting embodiments of the presently disclosed technique is shown in FIG. 6. After starting implementation at block 610, gas turbine sensors are selected at block 620. For example, the most useful sensors may be selected based on an area under one or more receiver operating characteristic curves (AUROC).

The operation sequence included in block 630 describes an implementation using open-begin-end dynamic time warping to identify potentially relevant subsequences in a long reference data time series. Initially, both the reference data and the query data are standardized at block 635, such as by using a mean and standard deviation of the reference data.

Constraints for the DTW algorithm are set up at block 640. As noted above, the constraints may include monotonicity constraints, boundary conditions, a warping window and step size and step pattern conditions. The constraints may be selected during the initial configuration of the analysis system, and may be chosen based on global characteristics of the gas turbine and sensor systems. Certain of the constraints may alternatively be chosen to process a particular reference data time series, and may be recomputed for each reference data time series. Certain constraints may be updated only periodically to take into consideration longer term changes in characteristics of the data.

Using OBE-DTW, a “best” match is then found at block 645 between the query data and a subsequence of the reference data series. The quality of the match is determined based on the cumulative distance between the two data series. The matched subsequence is then removed from the reference data series at block 650, together with 15-day before and after intervals. The operations of blocks 645 and 650 are then repeated until enough patterns are matched.

The operation sequence included in block 660 describes a clustering implementation. This implementation clusters similar time series data, which can then be examined to find clusters indicating underperformance. A number of sampled time series are first standardized at block 665 to remove the effects of series length on computed distances used in clustering.

Constraints for the DTW algorithm are set up at block 670. As noted above, some or all of the constraints may be established for each data set, or established periodically, or may be set only once. A symmetric step pattern is preferably used.

Using the DTW algorithm, pairwise distances are computed at block 875 between each pair of standardized time series. Using that distance information, the time series are then grouped at block 680 using a hierarchical clustering algorithm.

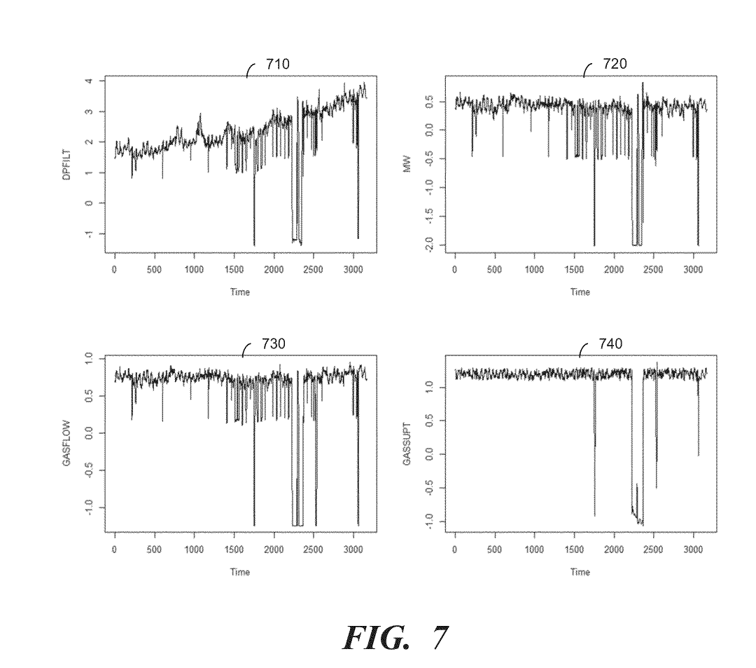

4. The above-described techniques were implemented on real gas turbine sensor data to evaluate the ability to detect underperformance. The working data for the OBE-DTW implementation was measured on two gas turbines identified as SM11 and MB12. The available sensor data of MB12 covers from May 2, 2012 at 23:15:00 to Apr. 17, 2014 at 03:55:00, and has 5-minute frequency. The MB12 data is used as reference data. The query data was selected from SM11 from Oct. 10, 2013 at 00:00:00 to Dec. 15, 2013 at 00:00:00. The standardized sensor plot of query data 710 shown in FIG. 7 indicates a clear trend with seasonality of the pattern of sensor “DPFILT” of query data. Three other key sensors, represented by standardized sensor plots 720, 730, 740, were selected with DPFILT to perform multi-dimensional DTW.

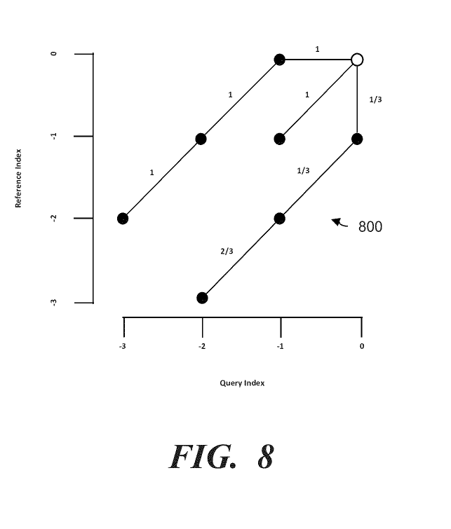

To implement OBE-DTW with the above-described data, both the query data and the reference data were standardized by mean and standard deviation of reference data. For this implementation comparing sequences of different length, a warping window cannot be imposed, as noted in Chotirat Ann Ratanamahatana, Eamonn Keogh, “Everything you know about Dynamic Time Warping is Wrong,” Tenth ACM SIGKDD International Conference on Knowledge Discovery and Data Mining (KDD-2004), Seattle, Wash., Aug. 22-25, 2004, the contents of which is hereby incorporated by reference in its entirety herein. The step pattern 800 used in searching the distance matrix for the optimal warping path is one of asymmetric step patterns such as those introduced in Sakoe et al. with a slope constraint of 2, as shown in FIG. 8.

In that implementation, a single sensor is used first to see if DTW can capture the pattern in the sensor DPFILT. Then, multi-dimensional OBE-DTW is performed to see if DTW can work with multi-dimensional cases. During the implementation, after a first matched pattern is obtained, that pattern, including the skipped data points within the range of that pattern, are removed from the reference data. Also, to make sure that the selected pattern is completely removed, a neighborhood around the pattern is removed as well; that is, data before the pattern, which has a length of 20% of the length of the matched pattern, is removed as well as data after the pattern.

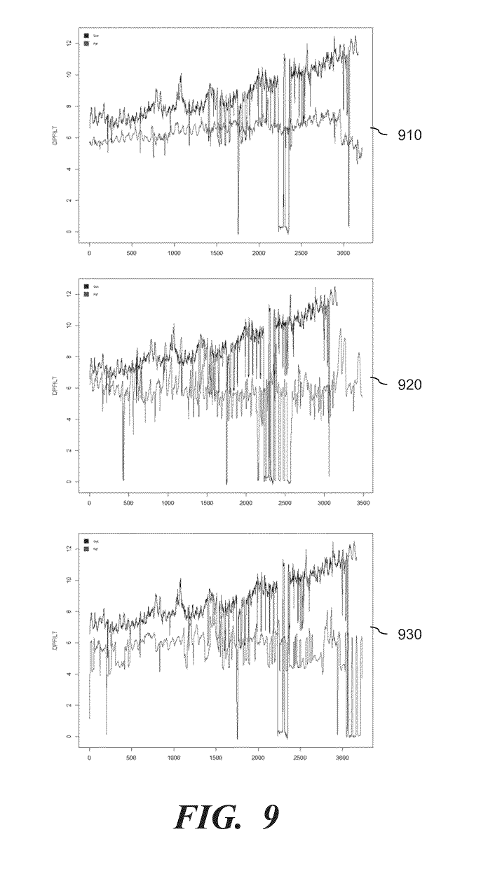

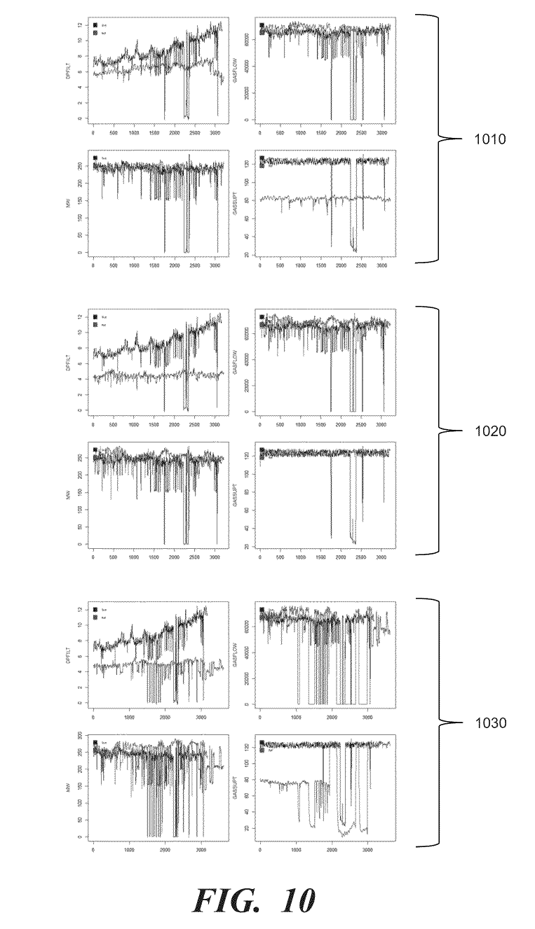

The matched results are found in FIGS. 9 and 10. The top three matched patterns with the single sensor DPFILT are visualized in the plots 910, 920, 930 shown in FIG. 9. The top three matched patterns with multiple sensor groups are visualized in the plot groups 1010, 1020, 1030 shown in FIG. 10. As exemplified in the plot 910 of FIG. 9, the trend in query data is matched with a trend in reference data, but the trend in reference data has a different slope.

The following table ranks matched patterns from a single sensor analysis and a multiple sensor analysis:

| | | | |
|---|---|---|---|
| Rank | From | To | Normalized Distance |

Single Sensor (DPFILT)

| | | | |
|---|---|---|---|
| 1 | 01/13/2014 11:45:00 | 02/28/2014 10:15:00 | 1.0057 |
| 2 | 05/05/2013 04:15:00 | 06/29/2013 19:45:00 | 1.1000 |
| 3 | 04/22/2013 03:45:00 | 08/28/2013 04:14:00 | 1.3157 |

Multiple Sensor

| | | | |
|---|---|---|---|
| 1 | 01/13/2014 21:15:00 | 02/28/2014 09:45:00 | 1.5325 |
| 2 | 08/31/2012 23:15:00 | 10/17/2012 04:45:00 | 1.9250 |
| 3 | 05/02/2012 23:45:00 | 07/02/2013 03:15:00 | 2.2839 |

From the table above, the matched patterns are very similar between single sensor results and multiple sensor results for the first match. But for the rest of matches, multiple sensors results seem to be better because the patterns found in them are clearer.

To demonstrate the clustering implementation, a gas turbine unit labeled CH11 is used as an example because it has more events than the SM11 and MB12 units used in OBE-DTW pattern search described above. There are 21 events within the period that sensor data is available. Based on general knowledge regarding gas turbines, an assumption is made that, in general, the gas turbine is in the status of underperformance within one month before events and operates normally after events. According to this assumption, three days of data before events is extracted and labeled as “1.” Because the event information doesn't show the specific time when a unit goes down, a threshold of 20% of the maximum megawatt reading is set to remove artifact data. A three-day wide window moves backward (into past) from the starting point of events. The window stops when the last reading of the window is higher than the threshold. Also, data from three days after events is extracted and labeled as “0.” It is possible that immediately after events, the unit may operate in an unstable status, so the data 15 days immediately after events is ignored. The labeled data is then standardized. The standardization can improve the performance of DTW, especially when doing clustering.

In the design of the clustering implementation, the step patterns must be symmetric; that is, both query data and reference data are matched to a common time series and the distance from A time series to B time series is equal to the distance from B time series to A time series. The symmetric step pattern with 0.5 slope constraint is used in this case. The following function shows the selected step pattern and its weights. Other step pattern candidates were investigated and yield no better results than the selected pattern.

$$ℊ ( i , j ) = min \{ \begin{matrix}ℊ ( i - 1 , j - 3 ) + 2 d ( i , j - 2 ) + d ( i , j - 1 ) + d ( i , j ) \\ ℊ ( i - 1 , j - 2 ) + 2 d ( i , j - 1 ) + d ( i , j ) \\ ℊ ( i - 1 , j - 1 ) + 2 d ( i , j ) \\ ℊ ( i - 2 , j - 1 ) + 2 d ( i - 1 , j ) + d ( i , j ) \\ ℊ ( i - 3 , j - 1 ) + 2 d ( i - 2 , j ) + d ( i - 1 , j ) + d ( i , j )\end{matrix} \} ,$$

where g(i,j) is the cumulative distance at the point (i,j) from the starting point in the path grid and d(x,y) is the local distance between point (i,j), the current point, and point (x,y).

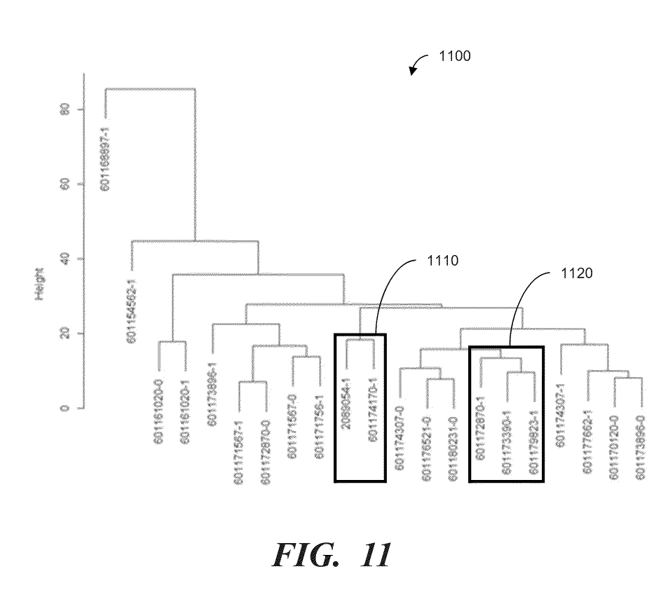

The hierarchical diagram 1100 of FIG. 11 shows results of a hierarchical clustering analysis of data from turbine CH11. The clustering results show that there are several clusters, specifically clusters 1110, 1120 in the sampled data, that indicate possible underperformance instances.

The above-described implementation shows that the DTW method can power the analysis of sensor data of gas turbines. The pattern matching methods can be used to find desired patterns and, consequently, find the suspicious periods that can indicate underperformance of a gas turbine. Utilizing the DTW normalized distance, the clustering methods can cluster different events into several small clusters for further analysis.

Although various embodiments that incorporate the teachings of the present invention have been shown and described in detail herein, those skilled in the art can readily devise many other varied embodiments that still incorporate these teachings, The invention is not limited in its application to the exemplary embodiment details of construction and the arrangement of components set forth in the description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

What is claimed is:

1. A computer-implemented method for detecting an underperformance of a gas turbine based on a plurality of reference time series of sensor readings, comprising:
standardizing the plurality of reference time series;
determining pairwise distances between each pair of the plurality of reference time series using a dynamic time warping algorithm having a symmetric step pattern;
clustering the candidate subsequences into classes using a hierarchical clustering algorithm based on the pairwise distances; and
detecting the underperformance of the gas turbine based on analysis of the classes.

2. The method of claim 1, wherein standardizing the plurality of reference time series further comprises standardizing by mean and standard deviation.

3. The method of claim 1, wherein using a dynamic time warping algorithm having a symmetric step pattern further comprises using a dynamic time warping algorithm having a step pattern having a 0.5 slope constraint.

4. The method of claim 1, wherein using a dynamic time warping algorithm having a symmetric step pattern further comprises using a dynamic time warping algorithm having a step pattern defined by
$$ℊ ( i , j ) = min \{ \begin{matrix}ℊ ( i - 1 , j - 3 ) + 2 d ( i , j - 2 ) + d ( i , j - 1 ) + d ( i , j ) \\ ℊ ( i - 1 , j - 2 ) + 2 d ( i , j - 1 ) + d ( i , j ) \\ ℊ ( i - 1 , j - 1 ) + 2 d ( i , j ) \\ ℊ ( i - 2 , j - 1 ) + 2 d ( i - 1 , j ) + d ( i , j ) \\ ℊ ( i - 3 , j - 1 ) + 2 d ( i - 2 , j ) + d ( i - 1 , j ) + d ( i , j )\end{matrix} \} ,$$
where g(i,j) is the cumulative distance at the point (i,j) from the starting point in the path grid and d(x,y) is the local distance between point (i,j), the current point, and point (x,y).

5. The method of claim 1, wherein clustering the candidate subsequences using a hierarchical clustering algorithm based on the pairwise distances further comprises:
using an unsupervised hierarchical clustering algorithm.

6. A computer-implemented method for detecting an underperformance of a gas turbine based on a reference time series of sensor readings, comprising:
accessing an annotated query time series of sensor readings, the annotated query time series containing at least one identified pattern indicating underperformance of a gas turbine;
selecting a candidate subsequence of the reference time series best matching the annotated query time series based on a minimized distance between the two time series using an open-begin-end dynamic time warping algorithm that releases a boundary condition of the reference time series;
removing from the reference time series the candidate subsequence best matching the annotated query time series together with time intervals before and after the candidate subsequence;
repeating the selecting and removing until a predetermined number of candidate subsequences is identified; and
detecting the underperformance of the gas turbine based on the candidate subsequences and the minimized distances.

7. The method of claim 6, wherein the time intervals are 15 days.

8. The method of claim 6, further comprising:
standardizing the reference time series and the annotated query time series before using the open-begin-end dynamic time warping algorithm.

9. The method of claim 8, wherein standardizing the reference time series and the query time series further comprises standardizing by mean and standard deviation of the reference time series.

10. The method of claim 6, wherein using an open-begin-end dynamic time warping algorithm further comprises using a dynamic time warping algorithm having an asymmetric step pattern.

11. The method of claim 6, wherein selecting a candidate subsequence of the reference time series best matching the annotated query time series further comprises:
choosing a single sensor dynamic time warping algorithm or a multi-sensor dynamic time warping algorithm based on which algorithm results in a candidate subsequence having a clearer match.

12. The method of claim 6, wherein identifying the plurality of candidate subsequences using the open-begin-end dynamic time warping algorithm further comprises using no warping window.

13. A computer-readable storage device having stored thereon computer readable instructions for detecting an underperformance of a gas turbine based on a plurality of reference time series of sensor readings, wherein execution of the computer readable instructions by a processor causes the processor to perform operations comprising:
standardizing the plurality of reference time series;
determining pairwise distances between each pair of the plurality of reference time series using a dynamic time warping algorithm having a symmetric step pattern;
clustering the candidate subsequences into classes using a hierarchical clustering algorithm based on the pairwise distances; and
detecting the underperformance of the gas turbine based on analysis of the classes.

14. The computer-readable storage device of claim 13, wherein standardizing the plurality of reference time series further comprises standardizing by mean and standard deviation.

15. The computer-readable storage device of claim 13, wherein using a dynamic time warping algorithm having a symmetric step pattern further comprises using a dynamic time warping algorithm having a step pattern having a 0.5 slope constraint.

16. The computer-readable storage device of claim 13, wherein using a dynamic time warping algorithm having a symmetric step pattern further comprises using a dynamic time warping algorithm having a step pattern defined by
$$ℊ ( i , j ) = min \{ \begin{matrix}ℊ ( i - 1 , j - 3 ) + 2 d ( i , j - 2 ) + d ( i , j - 1 ) + d ( i , j ) \\ ℊ ( i - 1 , j - 2 ) + 2 d ( i , j - 1 ) + d ( i , j ) \\ ℊ ( i - 1 , j - 1 ) + 2 d ( i , j ) \\ ℊ ( i - 2 , j - 1 ) + 2 d ( i - 1 , j ) + d ( i , j ) \\ ℊ ( i - 3 , j - 1 ) + 2 d ( i - 2 , j ) + d ( i - 1 , j ) + d ( i , j )\end{matrix} \} ,$$
where g(i,j) is the cumulative distance at the point (i,j) from the starting point in the path grid and d(x,y) is the local distance between point (i,j), the current point, and point (x,y).

17. The computer-readable storage device of claim 13, wherein clustering the candidate subsequences using a hierarchical clustering algorithm based on the pairwise distances further comprises:
using an unsupervised hierarchical clustering algorithm.
